(19) United States
(12) Patent Application Publication
(10) Pub. No.: US 2024/0416588 A1
(43) Pub. Date: Dec. 19, 2024

(54) FILTER DEVICE

(71) Applicant: EOS GMBH ELECTRO OPTICAL SYSTEMS, Krailling (DE)

(72) Inventors: Ulrich KLEINHANS, Prittriching (DE); Philip STRÖBEL, Weidenbach (DE)

(21) Appl. No.: 18/712,692

(22) PCT Filed: Sep. 29, 2022
(86) PCT No.: PCT/EP2022/077102

§ 371 Date: May 22, 2024

(30) Foreign Application Priority Data
Nov. 24, 2021 (DE) 10 2021 130 827.5

(51) Int. Cl. B29C 64/364; B01D 39/10; B01D 46/54; B01D 46/71; B33Y 40/00

(52) U.S. Cl. CPC B29C 64/364; B01D 39/10; B01D 46/546; B01D 46/71; B01D 2239/025; B01D 2239/0258; B01D 2239/0471; B33Y 40/00

(57) ABSTRACT

Disclosed is a filter device for an additive manufacturing device for purifying a process gas of the additive manufacturing device, where the filter device for purifying a process gas during operation has at least one permanent filter, where the permanent filter has at least one coating as well as a method for manufacturing such a filter device. Further disclosed is an additive manufacturing device as well as a method for additive manufacturing.

The invention relates to a filter device for an additive manufacturing device, a method for manufacturing such a filter device, an additive manufacturing device with such a filter device, as well as a method for additively manufacturing a component.

Additive manufacturing processes are becoming increasingly relevant in the production of prototypes and now also in series production. In general, “additive manufacturing processes” are manufacturing processes in which a manufacturing product or component is built up by adding material, usually on the basis of digital 3D design data. The build-up is usually done by applying a build-up material in layers and selectively solidifying it. The term “3D printing” is often used as a synonym for additive manufacturing, the manufacture of models, samples and prototypes using additive manufacturing processes is often referred to as “rapid prototyping” and the manufacture of tools as “rapid tooling”.

The selective solidification of the build-up material is often done by repeatedly applying thin layers of the usually powdery build-up material on top of each other and solidifying them by spatially limited irradiation, e.g. by means of light and/or thermal radiation, at the points that should, after manufacturing, belong to the manufacturing product to be manufactured. Examples of processes that work with irradiation are “selective laser sintering” or “selective laser melting”. The powder grains of the build-up material are partially or completely melted during the solidification with the help of the energy introduced locally at this point by the radiation. After cooling, these powder grains are then bonded together in the form of a solid body.

In such a production process, it is often necessary for a process gas for example for cooling or removal purposes (in particular with a fan) or a protective gas to be passed through the process chamber, in particular to provide a defined atmosphere, preferably with regard to the O₂ content. The exiting process gas generally carries particles of the build-up material and/or particles produced during the process, in particular metal condensates when metallic build-up materials are used, some of which are highly reactive and can react with small amounts of atmospheric oxygen even at room temperature with strong heat release and which can recondense into nanoparticles in the process chamber. Particularly in the case of reactive build-up materials (e.g. titanium, aluminium, magnesium or zirconium alloys), the protective gas preferably also serves as protection against uncontrolled reaction/explosion

In order to prevent contamination of the process gas with the particles, for example to counteract creeping contamination of the process chamber and/or the fan, it is necessary to filter the process gas after its exit from the process chamber.

Furthermore, common filters such as metal or polyester filters are permeable to metal condensate. This slip depends on the type of filter used, in particular the size of the openings or pores in the filter type used, as well as its age and duration of use.

Typically, with a filter of the “deep-bed filter” type it is observed that at the beginning of its use, a little more condensate is let through until a filter cake has built up and the filter is saturated in its depth.

The condensate that passed through also leads to the fact that further downstream filters, such as fine filters, are required, which will also be occupied and also need to be replaced after a certain operating time.

However, due to the high reactivity of the particles, uncontrolled filter fires or dust explosions can occur in the area of filters where the particles carried in the process gas accumulate. This risk is increased if, for example, a corresponding filter chamber is opened to change the filter(s), which increases a reaction probability due to the associated increased supply of oxidising agent, for example atmospheric oxygen.

The dedusting of the filter device is preferably done by means of a pressure surge that is directed against the direction of flow of the process gas. With conventional filter devices, it can be observed that the lower differential pressure level increases over the cycles and dedusting no longer works satisfactorily.

It is therefore desirable to provide filters that have a service life as long as possible.

It is therefore an object of the present invention to provide an improved or alternative filter device or a manufacturing device provided with a filter, wherein the filters have a service life as long as possible without this being at the expense of the filter effect and wherein safe filter removal is made possible when the filter is replaced in an additive manufacturing device.

Furthermore, it is desirable that the lower differential pressure level remains as constant as possible over the cycles and increases as little as possible when cleaning the filter device.

This object is solved by a filter device for an additive manufacturing device according to claim 1, a method for manufacturing such a filter device according to claim 18, a corresponding additive manufacturing device according to claim 19, and by a method for additive manufacturing according to claim 20.

A method according to the invention for manufacturing a filter device for an additive manufacturing device for purifying a process gas of the additive manufacturing device comprises the steps:
selecting a material for at least one coating of the permanent filter and
applying at least one coating to the permanent filter.

An additive manufacturing device according to the invention for manufacturing a component in an additive manufacturing process comprises a process space, a feed device for introducing a build-up material layer by layer into the process space, an irradiation unit for selective solidification of build-up material in the process space and a filter device according to the invention for purifying a process gas (exiting the process space) of the additive manufacturing device.

In the context of this description, the process space can also be referred to as process chamber.

A method according to the invention for the additive manufacturing of a component in an additive manufacturing process by means of an additive manufacturing device comprises the following steps:
introducing at least one layer of a build-up material into a process space of the manufacturing device,
selective solidification of the build-up material in the process space by means of an irradiation unit, and
purification of a process gas (exiting the process chamber and, in particular, moving in a closed circuit) of the additive manufacturing device by means of a filter device according to the invention.

Also according to the invention is the use of a permanent filter for purifying process gas in a filter device for an additive manufacturing device, preferably for use in a filter device according to the invention.

According to the invention, a permanent filter is also designed for the purification of process gas in a filter device for an additive manufacturing device, preferably for the purification of process gas in a filter device according to the invention.

Further, particularly advantageous embodiments and further embodiments of the invention result from the dependent claims as well as the following description, wherein the independent claims of one claim category can also be further developed analogously to the dependent claims and embodiments of another claim category and, in particular, individual features of different embodiments or variants can also be combined to form new embodiments or variants.

The terminology used in the description of the present disclosure serves only to describe certain embodiments and is not to be understood as limiting the subject matter. As used in the present description and claims, the singular forms “a”, “one” and “the” are to be understood as including the plural forms unless the context clearly dictates otherwise. This also applies vice versa, i.e. the plural forms also include the singular forms. It is also understood that the term “and/or” as used herein refers to and includes all possible combinations of one or more of the associated listed elements. It is further understood that the terms “includes”, “including”, “comprises” and/or “comprising”, when used in the present description and the claims, specify the presence of the specified features, steps, operations, elements and/or components, but do not exclude the presence or addition of one or more other features, steps, operations, elements, components and/or groups thereof.

In the present description and the claims, the terms “includes”, “comprises” and/or “comprising” may also mean “consisting of”, i.e. the presence or addition of one or more other features, steps, operations, elements, components and/or groups thereof is excluded.

The invention deals with the field of additive manufacturing, in which this manufacturing takes place in a (closed) process chamber through which a process gas is passed, which is subsequently filtered. The process gas is understood here to be the gas discharged, in particular extracted or transported away, from a process chamber, which, depending on the manufacturing process, can in particular also be an inert gas or comprise this. If at least one inert gas is used as the process gas, the process gas comprises in particular nitrogen, argon, helium and/or a mixture of inert gases.

If nitrogen is used as inert gas, the residual oxygen content therein is preferably less than 1.3% vol.-%.

If argon and/or helium is used as inert gas, the residual oxygen content therein is preferably less than 0.1% vol.-%.

In another preferred embodiment, the oxygen content in the process gas, in particular in the inert gas, is adjustable or controllable and is, for example, constant 100 ppm (0.01 vol.-%) or from 0.0001-3 vol.-% or from 0.001-3 vol.-%.

In another preferred embodiment, the water content in the process gas, in particular in the inert gas, is adjustable or controllable and is, for example, constant 100 ppm or the absolute humidity is 0.3 g/m³ or less.

The process gas can contain both unsolidified parts of a build-up material as well as process by-products such as condensates, for example metal condensates. Such components carried along in the process gas are summarised under the term “particles”.

A filter device for an additive manufacturing device according to the invention is used for the purification of a process gas of the additive manufacturing device. For purifying a process gas during operation the filter device has at least one, preferably dimensionally stable, permanent filter, wherein the permanent filter has at least one coating.

In the context of the invention, permanent filters (or “permanent filters”) are understood to be filters which, in contrast to conventional filter models, can remain in operation of the additive manufacturing device many times, for example over many cycles and/or permanently. A cycle is preferably understood here as the time after one cleaning of the filter device up to the next cleaning of the filter device.

For this purpose, a permanent filter is cleaned after a certain time, i.e. the filter cake is removed or ejected, preferably by a pressure surge, and thus material from the filter openings or filter pores or the filter material and/or a filter cake resting on the filter is removed. A permanent filter should contain a filter material that has such a high mechanical strength that it is not destroyed or damaged during cleaning as intended.

An example of a permanent filter is or comprises at least one metal filter with a metal mesh, metal fabric, metal fleece, sintered metal, in particular made of sintered metal particles, metal foam and/or metal sieve as filter material. In particular, a filter with a polyester fabric is not to be regarded as a permanent filter, at least if it does not have sufficient mechanical and thermal resistance.

A polyester filter is in particular disadvantageous, as the polyester filter is damaged by many cleanings over its service life and the polyester fibres become permeable. There is also a risk of fire upon filter changing and/or uncontrolled oxygen entry.

A filter that comprises or consists of a metal fabric is advantageous here. Such a filter is undamaged even after a plurality of cleanings and therefore allows for a long service life. Furthermore, metal filters are not flammable and even in the event of an uncontrolled fault, the user does not run the risk of an uncontrolled fabric fire with smoke and flame formation.

The advantage of a permanent filter is further that the risk of fire due to heating of dusty filtrate is significantly reduced, on the one hand due to the generally comparatively good heat conduction of the filter material and on the other hand because a permanent filter does not need to be replaced and its cleaning can be done under clearly defined, inert conditions. A cleaning can be carried out, for example, in that a pressure surge against the direction of the process gas, e.g. with an inert gas such as nitrogen is applied, and in that a filtrate clogging the pores and/or a filter cake resting on the filter is removed from the filter and can fall into a container. The good thermal conductivity of the permanent filter has a particularly positive effect if reactions can occur due to the entry of oxidising agent, for example oxygen, due to leakages in a system and/or upon a filter change and/or upon opening the process chamber.

The filter device has at least one (dimensionally stable) permanent filter for purifying a process gas during operation.

The filters used can be a deep-bed filter on the one hand and a surface filter on the other.

Deep-bed filters are regularly used to separate particles from flowing media. The separation effect takes place in the depth of the filter medium. In contrast, the actual separation effect in a surface filter is not only caused by the filter medium, but also by the filter cake that forms on the surface of the filter.

Preferably, the permanent filter according to the invention is a surface filter.

According to the invention, the permanent filter, in particular a metal filter of the permanent filter, comprises a coating, in particular a surface coating. In such a coating, the coating material is formed in a layer, in particular as an outermost surface of the filter.

The at least one coating is preferably formed in such a way that it forms a membrane on the surface of the permanent filter, preferably a membrane that adheres well to the surface of the permanent filter, and the permanent filter can thus enhanced act as a surface filter.

The at least one coating also preferably has the function of reducing the adhesion forces, van der Waals forces and/or electrostatic forces with which the particles, e.g. metal condensate or metal powder, adhere to the surface of the permanent filter and thus increases the cleanability or reduces the deposition of particles from the outset and produces an increased surface filtration. The surface coating is preferably an initial filter cake, e.g. a layer of extremely fine, sintered metal, which layer in turn prevents the incorporation of dust. This turns the permanent filter into a surface filter.

Such a coating also has the advantage that the slippage of metal condensate to a downstream fine filter can be largely prevented. The service life of the filter is also significantly increased.

The coating also leads to no or only a minimally higher pressure loss, as would be the case, for example, if a metal filter with a narrower mesh size were used.

In a preferred embodiment, the material of the permanent filter is different from the material of the coating.

It is advantageous here if the materials for the permanent filter and the coating are selected in such a way that a permanent, materially bonded connection is achieved. By this it should preferably be ensured that the coating does not peel off over the service life of the permanent filter. Such a materially bonded connection can be achieved by adhesion, cohesion or chemical reactions or chemical bonds, for example. In the case of a metal fleece coating, the materially bonded connection can also be created by welding.

According to one embodiment, the coating is in the form of nanofibres and/or nanoparticles. Such a coating can also be referred to as a “nano-coating”.

Here, nanofibres are preferably understood to be fibres that have a diameter of greater than 1 nm but less than 1000 nm. The length of the fibre is not directly limited and can be up to several micrometres or several millimetres.

Nanoparticles are preferably understood here to be particles that have a diameter of greater than 1 nm but less than 1000 nm.

In a preferred embodiment, the coating is essentially completely, i.e. preferably more than 90% by weight, in particular more than 95% by weight or more than 98% by weight, in the form of nanofibres.

In a preferred embodiment, the coating is essentially completely, i.e. preferably more than 90% by weight, in particular more than 95% by weight or more than 98% by weight, in the form of nanoparticles.

The coating may also be present as a mixture of nanofibres and nanoparticles as defined above.

In a preferred embodiment, the coating is an inorganic coating, for example based on metals, minerals and/or glass.

In another preferred embodiment, the coating is an organic coating, for example based on plastics and/or carbon.

According to one embodiment, the coating is characterised in that the coating comprises at least one plastic, a metal, glass fibres and/or carbon fibres or consists at least essentially of these.

By “essentially” it is understood that the coating preferably consists of more than 90% by weight, in particular more than 95% by weight or more than 98% by weight, of the respective material.

In a preferred embodiment, the coating comprises at least one metal.

Suitable metals include stainless steel, such as stainless steels 1.4401 and 1.4404.

The metal is preferably in the form of a metal fleece. A suitable metal fleece is preferably made up of fine metal threads, which generally have a diameter from 0.1 to 10 μm, in particular around 3 μm.

In a preferred embodiment, the coating comprises at least one plastic.

Suitable plastics include non-fluorinated plastics such as polyester, polyethylene oxide, poly(methyl methacrylate), nylon, polyvinyl chloride, cellulose acetate, and/or polyacrylonitrile.

In another embodiment, the at least one plastic comprises a fluorinated plastic.

Polytetrafluoroethylene (PTFE) is a particularly preferred plastic.

In a further preferred embodiment, the coating has a thickness from 5 to 5000 nm, preferably of at least 100 nm and/or at most 1000 nm, particularly preferably of at least 300 nm and/or at most 500 nm.

Such a thin surface coating is advantageous because it does not pose any additional fire hazard.

If a metal fleece is present as a coating, such a coating can also have a thickness of several micrometres, for example from 10 to 100 μm.

In a preferred embodiment, the coating comprises nanofibres, wherein the nanofibres have a diameter from 10 to 500 nm, preferably of at least 20 and/or at most 150 nm, particularly preferably of at least 30 and/or at most 100 nm.

The length of the nanofibres is not directly limited and can be several micrometres. Preferably, the nanofibres have a length of more than 3 μm or more than 5 μm. Preferably, the lengths of the nanofibres are from about 100 μm up to 1 mm or from about 100 μm up to 5 mm or from about 100 μm up to 10 mm.

In particular, the nanofibres have an aspect ratio (ratio of length to diameter) of more than 3:1, especially from 10:1 to 100,000:1.

Such nanofibres are advantageous because they are easy and inexpensive to manufacture. Furthermore, such nanofibres enable the formation of a type of membrane with very small openings. Nanofibres comprising PTFE are particularly inexpensive to produce and are characterised by their particular durability.

The length or the diameter of the nanofibres is preferably determined using electron microscopy.

In another preferred embodiment, the coating comprises nanoparticles, which preferably contain at least one plastic, wherein the nanoparticles have a D₅₀ from 1 nm to 1000 nm, in particular from 10 nm to 1000 nm. Preferably, the D₅₀ is from 20 nm to 200 nm, in particular about 100 nm.

The D₅₀ can preferably be determined by means of laser diffractometry or electron microscopy.

According to a preferred filter device, the permanent filter is formed temperature-resistant, in particular with respect to a continuous operating temperature, wherein the continuous operating temperature indicates the temperature at which the permanent filter is stable and resistant for at least 6 months, preferably at least 1 year, preferably at least 2 years and particularly preferably at least 5 years, such that a temperature resistance of the permanent filter is higher than 100° C. or higher than 150° C., preferably higher than 250° C., preferably higher than 350° C., particularly preferably higher than 500° C.

The respective coating material should be matched to the desired continuous operating temperature.

For example, plastic coatings are more suitable for lower continuous operating temperatures.

Inorganic coatings, for example, are suitable for particularly high continuous operating temperatures.

Accordingly, the purification of process gas according to a preferred method for additive manufacturing takes place at a process gas temperature (measured by a temperature sensor in the process chamber, in particular with a PT100 temperature sensor) of more than 40° C., preferably at a process gas temperature of more than 60° C. or more than 110° C., preferably at a process gas temperature of more than 150° C., preferably at a process gas temperature of more than 200° C., particularly preferably at a process gas temperature of more than 250° C., particularly preferably at a process gas temperature of more than 300° C.

The process gas temperature is preferably in the range of 40° C. to 60° C. However, a higher process gas temperature is also conceivable. Depending on the type of build-up material and the filters, a preferred temperature range is between 0° C. and 1000° C., in particular between 40° C. and 250° C. or even between 60° C. and 100° C. The temperature resistance of the permanent filter should always be higher than the process gas temperature.

According to a preferred filter device, the permanent filter is dimensionally stable in such a way that a working time of the permanent filter is essentially constant during operation of the filter device. The working time refers to the time between necessary cleanings of the filter, i.e. the time in which the filter can fulfil its task as intended. For a commercially available filter, this would correspond to the service life, i.e. the time until the filter has to be replaced after several, for example 200 or preferably more than 1000, cleanings (cycles). Since with a permanent filter basically a replacement is not necessary, in this case it is referred to as the working time.

According to a preferred filter device, the permanent filter comprises a metal filter and/or a ceramic filter and/or a mineral wool filter, in particular a glass wool filter or a basalt wool filter, preferably wherein a metal filter is formed from at least one corrosion-resistant steel and/or from a nickel-based alloy and/or from copper and/or from mixtures or alloys thereof.

A preferred corrosion-resistant steel is stainless steel. The advantage of a metal filter is the good temperature and oxidation resistance and the comparatively high thermal conductivity, which prevents spontaneous ignition of the condensate and/or better resists or slows it down. Corrosion resistance is advantageous, as in this case one can heat the filter and oxidise the filtrate in a controlled manner. Further advantages of a metal filter are high strength/inherent rigidity, which supports the basic function of the permanent filter and leads to a long service life even with many cleanings (many pressure surges), a smooth surface structure, which allows easy cleaning due to the merely loose adhesion of the filter cake, high abrasion resistance as well as no particle detachment. In addition, a metal filter allows a good flow rate, which leads to a low pressure loss across the filter and the filter can therefore be used more heavily compared to other filter meshes, which have high pressure losses (low flow rates). A metal filter also has a chemical and thermal resistance, whereby a risk of fire is significantly reduced. In addition, operation at higher gas temperatures, e.g. at gas temperatures greater than 500° C. or even greater than 800° C., would also be conceivable.

Preferably, the metal filter has a defined, in particular regular arrangement of the filter pores and is preferably made of a braided fabric or a perforated plate or a grid. A narrow pore size distribution with more than 50 pores per cm², in particular more than 100 pores per cm², is also preferred.

According to a preferred filter device, the permanent filter comprises a ceramic filter and/or a glass wool filter as an alternative or in addition to a metal filter. A mixture of different filter types (i.e. metal filter, ceramic filter and glass wool filter) is preferred depending on the application. By this, for example, the good thermal conductivity of a metal filter could be combined with the advantages of a ceramic or glass wool filter. For example, different filter stages can be formed in one filter.

According to a preferred filter device, a mesh size (or pore size) of a filter material of the permanent filter is not more than 30 μm, preferably not more than 20 μm, preferably not more than 8 μm. Preferably, the mesh size (or pore size) is at least 0.5 μm, preferably at least 1 μm, preferably at least 2 μm, particularly preferably 3 μm. It should be heeded here that a mesh size that is too large results in insufficient filtration. If it is too small, then the pressure losses are too high and the gas flow through the filter is no longer sufficient.

In the case of metal filters, instead of mesh sizes, it is often referred to openings or pores. The mesh size can be transferred analogously to the openings or pores.

The portion of open surface area is also frequently specified for metal filters. This is preferably from 10% to 99%, in particular of at least 15% and/or at most 30%, preferably of at least 30% and/or at most 60%.

According to a preferred filter device, the permanent filter has filter structures with a preferred diameter of between 1 μm and 1000 μm.

According to a preferred filter device, a (wire) diameter of fibres that form a filter material of the permanent filter is less than 100 μm, preferably less than 50 μm, preferably less than 20 μm, in particular less than 10 μm, particularly preferably less than 5 μm. However, the diameter is preferably greater than 1 μm.

If the metal filter comprises a grid of metal wires, metal wire diameters of at least 1 μm are preferred, depending on the application, but preferably thinner than 100 μm. Metal wires with the above-mentioned preferred dimensions for fibres are preferred.

The permanent filter can additionally comprise a support structure which is designed to support the permanent filter (in particular its filter surface), to keep it in shape and/or to increase the mechanical strength of the filter material. Such a support structure is particularly advantageous during the cleaning of a permanent filter by means of a pressure surge. Of course, such a support structure must not significantly impair the function of a filter. Therefore, the support structure is preferably constructed like a grid or a sieve, e.g. in the form of a wire mesh or a perforated flat element, e.g. a perforated plate. If a support structure comprises wires, these are preferably thicker than the fibres/wires of the filter material and preferably have a thickness of more than 100 μm, preferably more than 200 μm, but preferably less than 1000 μm, in particular less than 700 μm.

According to a preferred embodiment, the support structure runs parallel to the filter material of the permanent filter and preferably runs at least in a partial area on its dirty gas side and/or on its clean gas side. Because a contamination of the support structure must also be expected on the dirty gas side, but also for better gas permeability, it preferably has a grid structure with a mesh size greater than 1 mm.

According to a preferred embodiment, the support structure runs parallel to the filter material of the permanent filter and preferably runs at least in a partial area on its dirty gas side and/or on its clean gas side. Because a contamination of the support structure must also be expected on the dirty gas side, but also for better gas permeability, it preferably has a grid structure with a mesh size greater than 1 mm.

However, the support structure can also be integrated into the filter material, preferably in the form of reinforced or stronger elements of the filter material. Preferred in this respect is a filter material which comprises a support structure of parallel or grid-like arranged wires, e.g. a cylindrical filter which comprises rings of wires of the support structure in its outer surface or a pleated filter with star-shaped wires of the support structure. A grid of parallel (warp) wires running in one direction and (weft) wires interwoven with them orthogonally or diagonally is also preferred. According to a preferred embodiment, at least some (warp) wires are wires of the support structure (preferably with a thickness between 0.1 mm and 0.5 mm), with thinner (warp) wires of the filter material (preferably with a thickness between 1 μm and 100 μm) running between these (warp) wires. The (weft) wires are then preferably wires of the filter material, whereby particularly preferably some (weft) wires can also be wires of the support structure. In this way, the support structure forms a coarse grid into which the filter material is woven as a finer grid.

Preferably, a permanent filter is designed such that it has a sufficient filtration at a filter surface load of between 0.2 m/min and 1.3 m/min (volume flow/filter surface). As far as the filter surface load caused by the process gas is concerned, a lower value is favourable compared to a higher value. However, values that are too low mean that filter surface remains unused and thus causes unnecessary costs. Therefore, a filter surface load of 0.2 to 1.3 m/min is preferred during operation, preferably less than 0.8 m/min, more preferably less than 0.6 m/min.

Preferably, the thermal conductivity of the permanent filter, at least its filter material, in particular that of the wires or fibres of a braid, is greater than 0.5 W/(m*K), in particular greater than 10 W/(m*K), especially preferably greater than 20 W/(m*K). The advantage of this is that the risk of the filtrate catching fire is reduced by the rapid dissipation of localised heat. Since the heat dissipation of a polyester filter, for example, is not very good, an ignition already occurs at lower temperatures than with such a permanent filter.

According to a preferred filter device with a fibre fabric, the weave is regular and/or chaotic. The advantage of such a design is a robust structure, low damage during cleaning and therefore a particularly long service life.

According to a preferred filter device, a dirty gas side of the permanent filter that comes into contact with the process gas to be cleaned has a pleated surface, preferably meandering, at least in certain regions. Preferably, a number of folds are arranged in the surface to form a pleated surface of the dirty gas side. The folds for pleating are particularly preferably folds in a continuous fabric. Alternatively, the folds are preferably welded and/or glued together. With regard to this preferred embodiment, the outer fabric is therefore pleated and not bent into curves (even though this may well be preferred in other applications). Pleating significantly increases the filter surface area for the same volume, e.g. by a factor of 2 to 3. There is also a non-linear relationship between filter surface area and service life. A doubling of the filter area (e.g. by pleating) can lead to a service life that is 4 to 8 times longer. Preferably, the folds are so narrow that as much filter area per cartridge as possible is achieved and so wide that the filtered condensate can still be easily cleaned (i.e. comes out of the folds) during cleaning via a pressure surge. Preferably, a filter comprises 100 to 300 folds with a filter diameter of at least 20 cm. Even if a higher number of folds is better, it must be heeded that a folding that is too narrow has a negative effect on the cleanability of the filter. The depth of the fold is preferably at least 20 mm, more preferably at least 30 mm.

According to a further preferred filter device, a dirty gas side of the permanent filter that comes into contact with the process gas to be cleaned has a rounded meander shape, e.g. a wave shape or a meander-like rectangular shape, at least in certain regions. The width of the respective structures (corresponding to a wavelength of a wave structure) is preferably greater than 1 cm, preferably greater than 2 cm and/or preferably less than 10 cm, preferably less than 4 cm. Preferably, the depth of the structures is at least 20 mm, more preferably at least 30 mm. Preferably, a filter comprises 100 to 300 of these structures with a filter diameter of at least 20 cm.

Preferably, a filter surface area of a single permanent filter is at least 0.5 sqm, preferably at least 1 sqm, particularly preferably at least 3 sqm (sqm=square metre). For large systems with high volume flows, more surface area makes sense, but this can also be achieved by connecting several filters in parallel and/or connecting several filter chambers in parallel. As the susceptibility of the filters to mechanical loads also increases with a larger surface area, the filter surface area is preferably at most 20 sqm, in particular at most 3 sqm per cartridge, e.g. 2 sqm per cartridge.

According to a preferred filter device, the permanent filter is a cartridge filter and/or a plate filter, with preferably meander-shaped cross-section.

According to a preferred filter device, the permanent filter is arranged in the filter device in such a way that a dirty gas side that comes into contact with the process gas to be cleaned is an outer surface of the permanent filter.

Alternatively or additionally, the permanent filter is preferably arranged in the filter device in such a way that a dirty gas side that comes into contact with the process gas to be cleaned is an inner surface of the permanent filter (located inside the filter). This variant of the dirty gas side located inside the filter has the advantage that the cleaned condensate gets caught on the inside of the filter, which results in a reduced risk of fire during replacement and thus a lower risk for operators in the event of incorrect operation. In addition, in the case of inertisation when removing the filter plates, the inert gas can be used more effectively (i.e. cost-saving due to the smaller volumes required) by introducing it on the inside of the filter plates. A solid inert medium would also be conceivable, for example sand and/or expanded glass granulate. The advantage of a variant with an external and an internal filter surface is the gain in filter surface area with the same external circumference.

According to a preferred filter device, the permanent filter is designed in such a way that particles cleaned away from the permanent filter can be used (directly) as build-up material in a (renewed) additive manufacturing process. The metal condensate, which is collected in a collecting container after the filter has been cleaned, can be recycled possibly without purification, in particular because metal filters have untreated surfaces.

According to a preferred filter device, the permanent filter is designed so that an oxidation reaction of particles present in the permanent filter can be initiated (triggered), whereby the permanent filter is preferably coupled to an energy input source, and preferably a metal mesh or part of a metal mesh of the permanent filter represents a heating element. In particular, the filter comprises insulated wires (e.g. in a braid), which form the heating element. Preferably, a metal mesh of the filter serves as an active resistance heater. The advantage of such a heater is that chemical processes such as oxidation can be stimulated in a controlled manner, so that a targeted or controlled reaction of the filter cake can be achieved directly on the filter.

In a preferred method for additive manufacturing, a purification of the process gas and/or a cleaning of the permanent filter is done in such a way that particles cleaned away from the permanent filter can be used as build-up material in a (renewed) additive manufacturing process.

Preferably, the permanent filter of the filter device is designed and arranged in the filter device in such a way that the permanent filter can be cleaned in a cleaning operation of the filter device running parallel to a building process of the manufacturing device. An “online cleaning” in this respect, i.e. cleaning without interrupting the building job, is preferably carried out at a lower pressure than a cleaning during an interruption of the building job or between building jobs, which should carried out at approx. 5 bar. A preferred pressure range for an online cleaning is between 2 and 5 bar.

It is preferable to use at least two filter chambers connected in parallel, whereby one of which is separated from the gas flow during cleaning. For example, the area around this could be enriched with oxygen in a controlled manner (and this filter chamber heated) and the filter cake oxidised in a controlled manner without endangering or influencing the building process.

In a preferred method for additive manufacturing, the permanent filter is cleaned during the (ongoing) additive manufacturing process, in particular without an interruption of the manufacturing process.

In a preferred method for additive manufacturing, a cleaning of the permanent filter is carried out in dependence of a differential pressure value of process gas (via the permanent filter). For this purpose, a preferred differential pressure value is at least 10 mbar, preferably at least 20 mbar, preferably at least 30 mbar, particularly preferably at least 40 mbar.

Alternatively or additionally, a cleaning pressure surge for cleaning the permanent filter is less than 5 bar, preferably less than 4 bar, preferably less than 3 bar, particularly preferably 2.5 bar. However, this pressure depends on the surface area and shape of the permanent filter. It may also be preferred that a cleaning pressure surge has more than 2 or preferably more than 3 bar, in particular more than 4 bar. Preferably, the filter device comprises buffer volumes which absorb the pressure surge.

In the method according to the invention for producing a filter device for an additive manufacturing device for purifying a process gas of the additive manufacturing device, wherein the filter device for purifying a process gas during operation comprises at least one permanent filter as described above, comprising the steps:
selecting a material for the at least one coating of the permanent filter,
applying the at least one coating to the permanent filter.

The respective coating material should be matched here with regard to the desired effects, such as the desired continuous operating temperature, an improved cleanability, the filter efficiency and the service life.

In principle, the at least one coating can be applied via any suitable processes.

Preferably employed are the direct application of nanofibres and/or nanoparticles, meltblown lamination, electrochemical processes, electro spin coating, immersion baths, spraying processes, melting processes and/or sputtering processes.

The invention is explained once more in more detail below with reference to the attached figures using execution examples. In the various figures, identical components are labelled with identical reference numbers. The figures are generally not to scale.

They show:

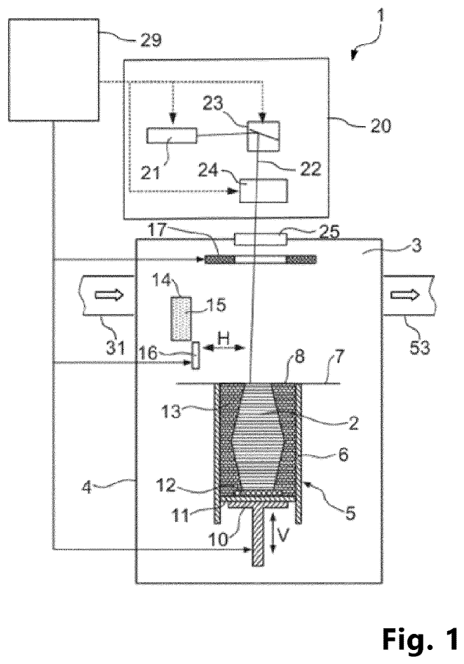

FIG. 1 a schematic view, partially shown in section, of a device for the generative manufacture of a three-dimensional object.

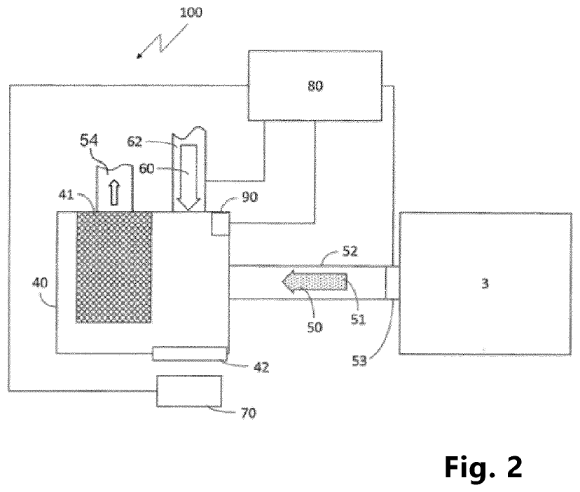

FIG. 2 a schematic view, partially shown in section, of a filter device for filtering in a process gas.

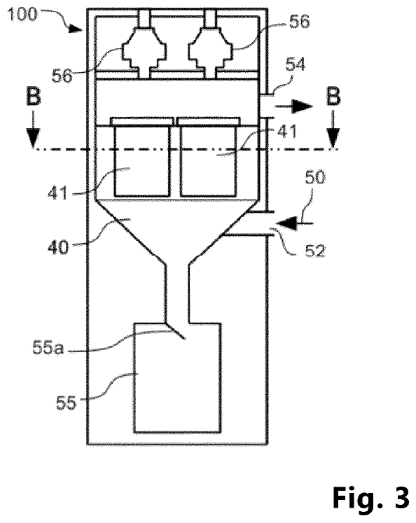

FIG. 3 a schematic view, partially shown in section, of a filter device for filtering in a process gas.

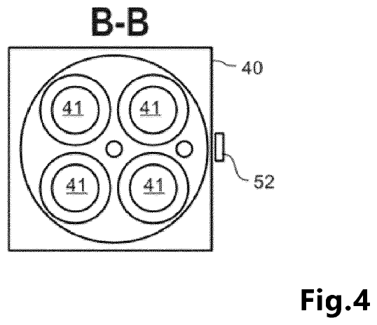

FIG. 4 a schematic sectional view of FIG. 3.

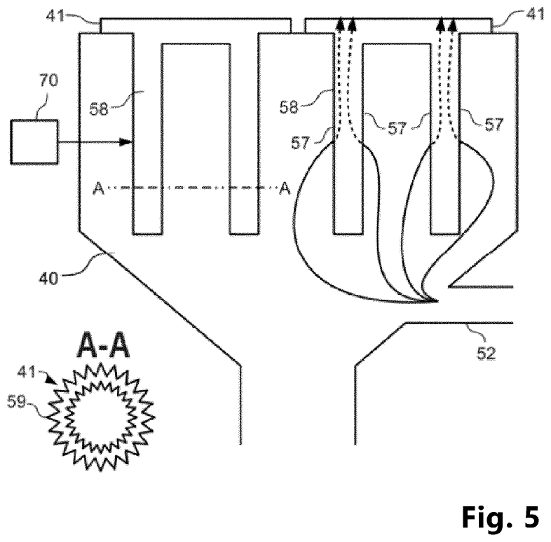

FIG. 5 a schematic side view, shown in section, of a filter device for filtering in a process gas.

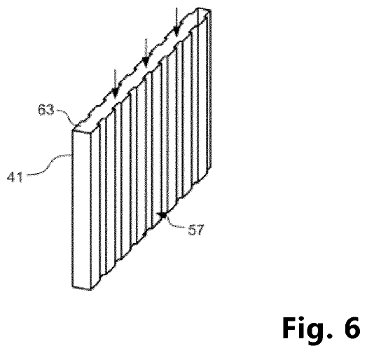

FIG. 6 a schematic perspective view of a further preferred permanent filter in the form of a plate filter.

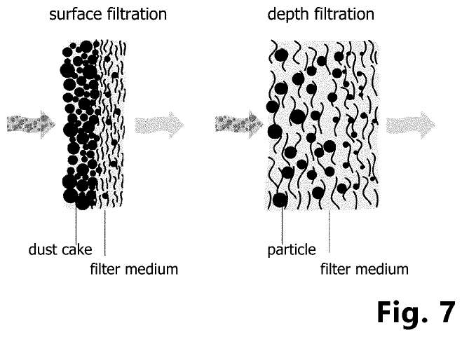

FIG. 7 a schematic comparison of a surface filter with a deep-bed filter.

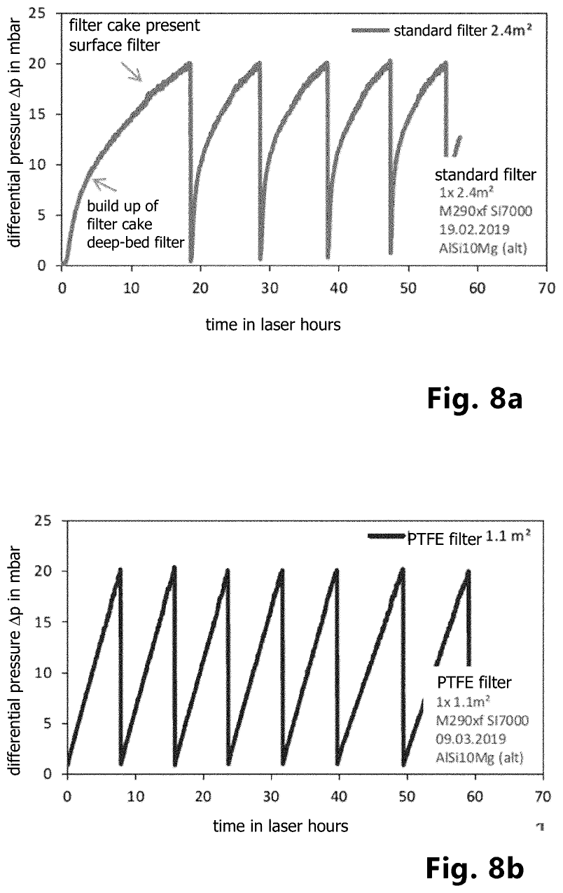

FIG. 8 shows a comparison of the filter curves of a deep-bed filter and a surface filter.

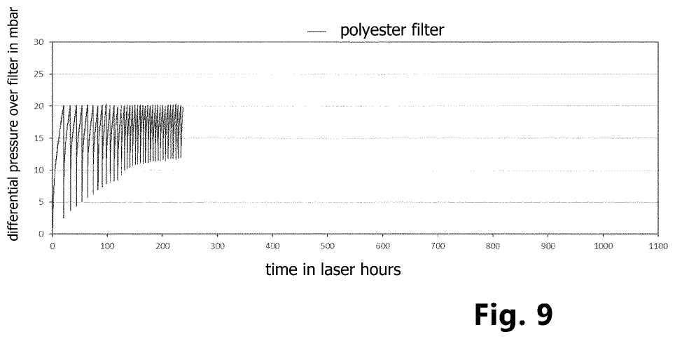

FIG. 9 shows a filter curve over the service life of a standard polyester filter.

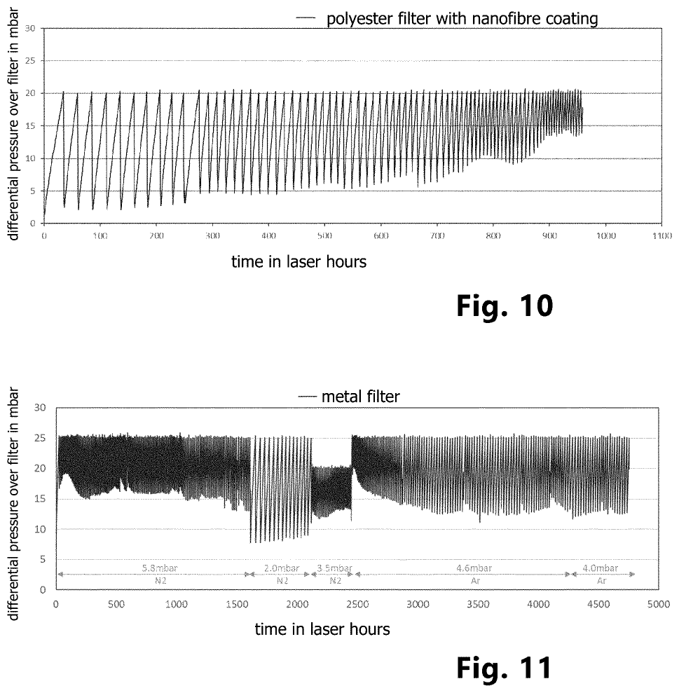

FIG. 10 shows a filter curve over the service life of a polyester filter with nano-coating.

FIG. 11 shows a filter curve over the service life of a metal filter.

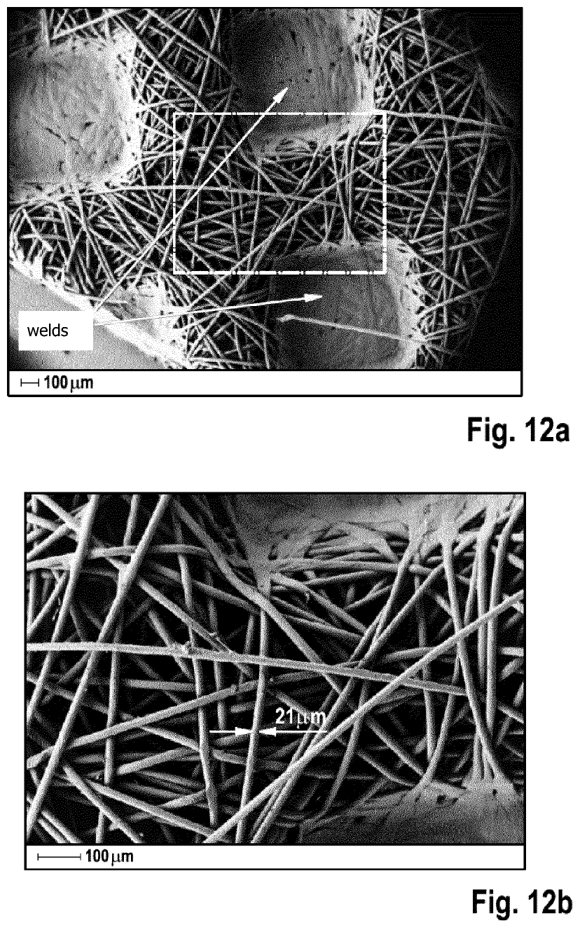

FIG. 12 shows SEM images of a standard polyester filter at 100× and at 250× magnification.

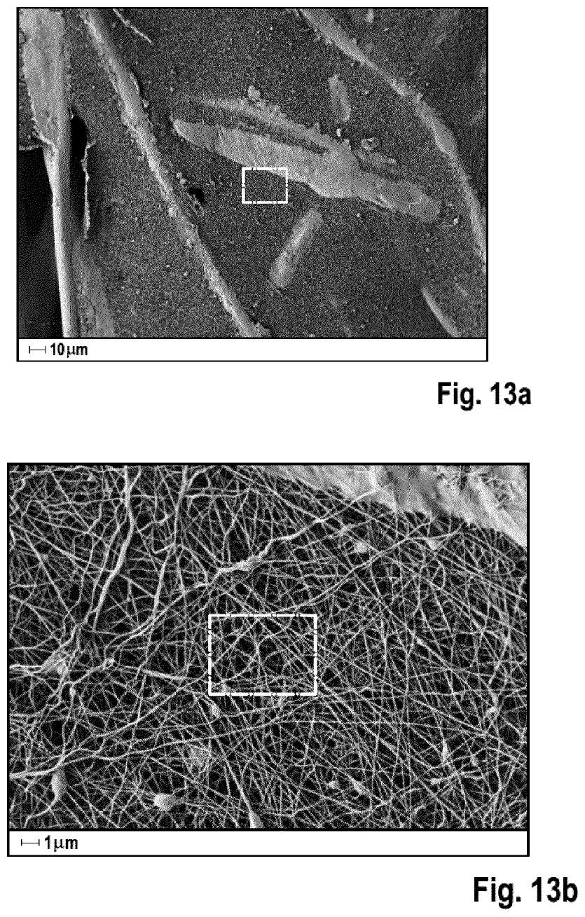

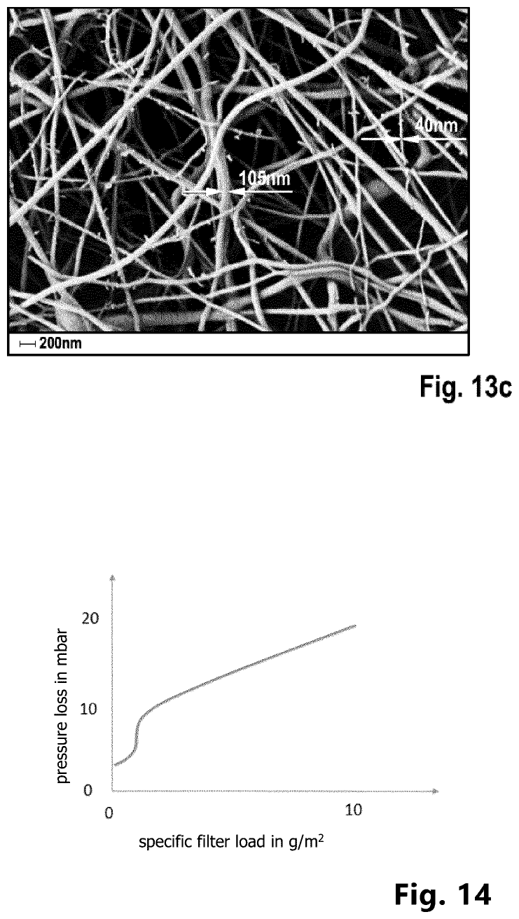

FIG. 13 shows SEM images of a filter with nano-coating at 1000×, at 10000× and at 50000× magnification.

FIG. 14 shows a diagram relating to the filter resistance and the gas permeability.

In the following, a device for the generative manufacture of a three-dimensional object is described with reference to FIG. 1. The device shown in FIG. 1 is a laser sintering or laser melting device 1. To build an object 2, it contains a process chamber 3 with a chamber wall 4.

An upwardly open container 5 with a container wall 6 is arranged in the process chamber 3. A working plane 7 is defined by the upper opening of the container 5, whereby the area of the working plane 7 within the opening that can be used to build up the object 2 is referred to as the building panel 8. In addition, the process chamber 3 comprises a process gas supply 31 associated with the process chamber as well as an outlet 53 for process gas. A support 10 movable in a vertical direction V is arranged in the container 5, to which a base plate 11 is attached, which closes off the container 5 at the bottom and thus forms its base. The base plate 11 can be a plate formed separately from the carrier 10, which is attached to the carrier 10, or it can be formed integrally with the carrier 10. Depending on the powder and process used, a building platform 12 can also be attached to the base plate 11 as a building base on which the object 2 is built-up. However, the object 2 can also be built-up on the base plate 11 itself, which then serves as a building base. In FIG. 1, the object 2 to be formed in the container 5 on the building platform 12 is shown below the working plane 7 in an intermediate state with several solidified layers surrounded by unsolidified build-up material 13.

The laser sintering device 1 further contains a storage container 14 for a powdery build-up material 15 that can be solidified by electromagnetic radiation and a coater 16 that can be moved in a horizontal direction H for applying the build-up material 15 within the construction field 8. Preferably, the coater 16 extends transversely to its direction of movement over the entire area to be coated.

Optionally, a radiant heater 17 is arranged in the process chamber 3, which serves to heat the applied build-up material 15. As radiant heater 17 an infrared heater can be provided, for example.

The laser sintering device 1 also contains an exposure device 20 with a laser 21, which generates a laser beam 22 that is deflected by a deflection device 23 and focussed onto the working plane 7 by a focussing device 24 via a coupling window 25, which is attached to the top of the process chamber 3 in the chamber wall 4.

Furthermore, the laser sintering device 1 includes a control unit 29, via which the individual components of the device 1 are controlled in a coordinated manner for carrying out the building process. Alternatively, the control unit can also be located partially or completely outside the device. The control unit may include a CPU whose operation is controlled by a computer program (software). The computer program can be stored separately from the device on a storage medium from which it can be loaded into the device, in particular into the control unit.

Preferably, a powdery material is used as the build-up material 15, whereby the invention is directed in particular to build-up materials forming metal condensates. In the sense of an oxidation reaction and thus a fire hazard, build-up materials containing iron and/or titanium are mentioned in particular, but also materials containing copper, magnesium, aluminium, tungsten, cobalt, chromium and/or nickel, as well as compounds containing such elements.

In operation, to apply a powder coating, at first the support 10 is lowered by a height that corresponds to the desired coating thickness. The coater 16 first moves to the storage container 14 and takes a sufficient quantity, for the application of a layer, of the build-up material 15 from it. It then travels over the building panel 8, applies powdery build-up material 15 there to the building base or an already existing powder layer and draws it out to form a powder layer. The application takes place at least over the entire cross-section of the object 2 to be manufactured, preferably over the entire building panel 8, i.e. the area bounded by the container wall 6. Optionally, the powdery build-up material 15 is heated to a working temperature by means of a radiant heater 17.

Subsequently, the cross-section of the object 2 to be produced is scanned by the laser beam 22 so that the powdery build-up material 15 is solidified at the points that correspond to the cross-section of the object 2 to be produced. The powder grains are partially or completely melted at these points by means of the energy introduced by the radiation, so that after cooling they are present bonded together as solid bodies. These steps are repeated until the object 2 is finished and can be removed from the process chamber 3.

FIG. 2 shows a schematic view, partially shown in section, of a filter device 100 for filtering and here also for post-treatment of particles 51 entrained in a process gas 50 of a device for generatively producing three-dimensional objects in conjunction with a device 1 according to FIG. 1 in accordance with a first embodiment of the present invention. The particles 51 and the process gas 50 entraining the particles are shown by the corresponding arrow. The process gas 50 entraining the particles 51 is discharged, for example sucked-off, from the process chamber 3 via an outlet 53 into the feed 52 of the process gas 50 to the filter chamber 40. In addition to an inlet for the supply 52 of the process gas 50 and the particles 51 entrained therein, the filter chamber 40 has an inlet for an oxidising agent 60 for post-treatment supplied via an oxidising agent supply 62, also shown as a corresponding arrow. The oxidising agent supply 62 is aligned with the process gas 50 entraining the particles 51 emerging from the feed 52 in such a way that the oxidising agent 60 can penetrate the particle environment of the particles 51 in the region of the initiation of the oxidation reaction described below. As a means for the initiation of the oxidation reaction, an energy input source 70 designed as a radiant heater is provided here, which couples its thermal radiation into the filter chamber 40 via a transparent area 42 of the filter chamber 40 and significantly absorbed from the particles 51 entrained in the process gas 50, so that these are heated in a targeted manner. The supply of the oxidising agent 60 into the particle environment of the particles 51, in combination with the particle temperature generated by the energy input source 70, leads to an oxidation reaction in which the particles 51 burn off in a controlled manner and/or are passivated, at least in a guided oxidation reaction, to such an extent that their tendency to burn and explode is sufficiently impeded. The process gas 50 entraining the particles 51 or now particle residues is then discharged through the (temperature-resistant) filter 41, at which the particles 51 or particle residues remain according to the filter characteristics. The filtered process gas can exit the filter 41 from a clean gas outlet 54 and, for example, be fed back into a process via a process gas supply 31 (see e.g. FIG. 1).

The filter device 100 can also have a separator, not shown, so that particles 51 formed from unsolidified build-up material 13 are separated from the process gas 50 so that they are not fed to the post-treatment.

In the embodiment according to FIG. 2, the oxidising agent supply 62, the feed 52 of the process gas 50 and the energy input source 70 are arranged in such a way that the oxidation reaction is initiated by the energy input source 70 in the particle environment in which the oxidising agent 60 meets the process gas 50 entraining the particles 51 and thereby mixes the particle environment. Alternatively, the particles 51 entrained in the process gas 50 can also first be heated to a temperature which then leads to the initiation of an oxidation reaction when the particles 51 come into contact with the oxidising agent 60. Similarly, the energy input for the initiation of the oxidation reaction can only take place when the mixing of the particle environment with the oxidising agent 60 has already taken place, provided that the oxidising agent content is still sufficient. This refers to both a spatial as well as a temporal view.

Furthermore, the filter device 100 in FIG. 2 has a controller 80 which can control the oxidising agent supply 62 and thus the quantity of oxidising agent 60 supplied to the filter chamber, for example via valves, the outlet 53 and thus the quantity of process gas 50 and particles 51 entrained therein, as well as the energy input source 70. To control at least one of these devices, which can be controlled by the controller 80, a process monitoring 90 is provided, which monitors at least the oxidising agent content, the particle quantity or the temperature in the filter chamber 40. The control is carried out via the controller 80, but can also be formed by a separate unit. The controller 80 can also be included in the control unit 29 of the laser sintering device 1 or be assigned to the filter device 100.

FIG. 3 is a schematic view, partially shown in section, of a filter device 100 for filtering a process gas 50. The process gas 50 enters the filter device 100 through a dirty gas inlet (feed 52). The line shown as feed 52 comes from the suction of a process chamber (see e.g. FIG. 1).

The incoming process gas 50 then flows through the filter chamber 40, which here has the shape of a funnel that opens into the particle collection container 55. Larger particles bounce off the edge of the filter chamber 40 and fall directly into this particle collection container 55, while lighter particles are further entrained with the process gas and filtered out of the process gas 50 by the permanent filters 41. Above the filters cleaning units 56 with tanks are located, which can clean the filters 41 by means of cyclical pressure surges. Particles removed from the filters 41 fall into the particle collection container 55. The filtered process gas exits the filter device 100 again from the clean gas outlet 54.

FIG. 4 is a schematic sectional view of FIG. 3: The four permanent filters 41 are clearly recognizable, which are designed as filter cartridges, and a pipe in the centre, which opens into the particle collection container 55 and can be closed by a shut-off flap 55a to prevent particles from escaping when the particle collection container 55 is replaced.

FIG. 5 is a schematic side view, shown in section, of a filter chamber 40 of a filter device 100 for filtering in a process gas 50, as shown, for example, in FIG. 3. A special feature are the permanent filters 41, which are hollow cylinders here with a pleated (designed in folds 59) filter material 58 (see also section A-A). Both the pleating as well as the design as a hollow cylinder, each with an internal and an external dirty gas side 57, contribute to an increase in the effective filter surface.

In this example, the filter device 100 comprises an energy input source 70 for the left filter 41, to which the filter 41 is coupled. This energy input source 70 is used here to heat a metal mesh in the filter material 58, so that the filter 41 represents a heating element. This serves to bring about a controlled oxidation of the filtered particles. The heating effect can be achieved in that wires of the filter 41 are designed as (insulated) heating wires and the energy input source 70 supplies these wires with current.

FIG. 6 is a schematic, perspective view of a further preferred permanent filter 41. This one is designed as a filter plate with an external dirty gas side. A process gas flow (not shown here) enters the filter 41 from the outside and particles are filtered out on the dirty gas side 57. The cleaned process gas flow exits the filter 41 in the direction opposite the arrows (top). For cleaning, an inert gas is blown into the filter in the direction of the arrows.

FIG. 7 shows a schematic comparison of a surface filter with a deep-bed filter. For surface filtration, a thin barrier layer is often applied on the flow side, which largely prevents a penetration of the particles. The filter medium itself remains largely free of particles. Surface filters increasingly build up a dust or filter cake, which itself contributes to filtration with increasing thickness.

With depth filtration, the separation of the material occurs to a large extent in the filter medium itself. Particles, especially condensate particles, accumulate in the filter medium over time and are difficult to clean away. Depth filtration is suitable for comparatively low particle concentrations and surface loads.

FIG. 8 shows a comparison of the filter curves of a deep-bed filter (FIG. 8a) and a surface filter (FIG. 8b).

In FIG. 8a the filter curve of a standard deep-bed filter with a surface area of 2.4 m² is shown. The non-linear increase in pressure shows that a filter cake has to build up first. Towards the end of the curve, this filter cake acts like a membrane and the deep-bed filter thus acts like a surface filter. Furthermore, the time between cleanings does not decrease linearly, which could be due to the fact that gaps between the folds become clogged and thus the effective filtration surface decreases over time. In addition, the lower limit of the pressure increases after cleaning, which can also result in a decrease in cleaning efficiency.

In FIG. 8b the filter curve of a standard surface filter with a surface area of 1.1 m² is shown. A linear increase in pressure over time shows, i.e. the filter acts as a surface filter right from the start. Furthermore, the time between two cleanings remains essentially constant. The lower limit of the pressure also remains essentially stable. A direct comparison with the deep-bed filter shows that less filter surface area is required to achieve a similar performance. In addition, the surface filter incorporates less material, which results in a lower fire load.

FIG. 9 shows a filter curve over the service life (240 h) of a standard polyester filter. The lower limit of the pressure rises sharply, which means that cleaning is inefficient.

FIG. 10 shows a filter curve over the service life (994 h) of a polyester filter with nano-coating. The lower limit of the pressure increases more slowly, the cleaning becomes less efficient over time.

FIG. 11 shows a filter curve over the service life (>5000 h) of a metal filter. Although the measurements were stopped after 4800 h, no deterioration in filter performance was recognisable. Although the lower limit of the pressure is slightly higher, as the metal mesh represents a greater resistance, cleaning occurs relatively frequently but hardly deteriorates in the period shown. Various flows and gases were tested in the measurement.

FIG. 12 shows SEM images of a standard polyester filter at 100× (FIG. 12a) and at 250× magnification. In FIG. 12a, the welds are clearly recognisable. These lead to a loss of active filter area, but are necessary to hold the fibres together. In FIG. 12b fibres with a diameter of 21 μm are recognizable. Condensate agglomerates that fly towards the filter are in a size range around 20 nm. This means that the filter can only be effective due to depth filtration and a filter cake. A fine filter is also required for the start-up process.

FIG. 13 shows SEM images of a filter with nano-coating at 1000× (FIG. 13a), at 10000× (FIG. 13b) and at 50000× magnification (FIG. 13c). In FIGS. 13a and 13b the much more closed surface compared to the filter in FIG. 12 can be seen. In FIG. 13c, fibres with a diameter of 30 to 120 nm can be seen. Typical fibres are in the range of 80 nm. This means that the filtration effect towards condensate agglomerates is favourable on the surface.

FIG. 14 shows a diagram relating to the filter resistance and the gas permeability. The filter resistance and the gas permeability are largely dependent on the filter occupancy and the dust (in particular the fineness of the dust), the available filter surface and the gas volume flow and gas density.

The filter surface area here is 4×1.7 m² metal filter=6.8 m².

The velocity at the mesh is: v=360 m³/h/6.8 m²=0.014 m/s.

The bulk density of the condensate is condensate: 0.05 g/cm³.

The layer thickness before cleaning is 0.2 mm.

This results in a condensate volume of 0.05 g/cm³*0.02 cm=0.001 g/cm².

Cleaning is carried out at 20 mbar, as the resistance would otherwise be too high. After cleaning, residues remains on the filter, which lead to the fact that the initial resistance of 5 mbar is no longer achieved.

### LIST OF REFERENCE SIGNS

1 laser melting device
2 object/component
3 process chamber
4 chamber wall
5 container
6 container wall
7 working plane
8 building panel
10 support
11 base plate
12 building platform
13 build-up material
14 storage container
15 build-up material
16 coater
17 radiant heater
20 irradiation device/exposure device
21 laser
22 laser beam
23 deflection device/scanner
24 focussing device
25 coupling window
29 control unit
31 process gas supply
40 filter chamber
41 filter/permanent filter
42 transparent area
50 process gas
51 particles
52 feed
53 outlet
54 clean gas outlet
55 particle collection container
55a shut-off flap
56 cleaning unit
57 dirty gas side
58 filter material
59 fold
60 oxidising agent
62 oxidising agent supply
70 energy input source
80 controller
90 process monitoring
100 filter device
H horizontal direction
V vertical direction

1. Filter device for an additive manufacturing device for purifying a process gas of the additive manufacturing device, wherein the filter device for purifying a process gas during operation has at least one permanent filter, wherein the permanent filter has at least one coating.

2. Filter device according to claim 1, wherein the coating is in the form of nanofibres and/or nanoparticles.

3. Filter device according to claim 1, wherein the coating comprises at least one plastic, a metal, mineral fibres, glass fibres and/or carbon fibres or consists essentially of these.

4. Filter device according to claim 3, wherein the at least one plastic comprises polyester, polyethylene oxide, poly(methyl methacrylate), nylon, polyvinyl chloride, cellulose acetate, polyacrylonitrile and/or a fluorinated plastic.

5. Filter device according to claim 4, wherein the at least one plastic comprises a polytetrafluoroethylene.

6. Filter device according to claim 1, wherein the coating has a thickness of at least 300 nm and/or at most 500 nm.

7. Filter device according to claim 1, wherein the coating comprises nanofibres and wherein the nanofibres have a diameter of at least 30 and/or at most 100 nm.

8. Filter device according to claim 1, wherein the coating comprises nanofibres and wherein the nanofibres have an aspect ratio of more than 3:1.

9. Filter device according to claim 1, wherein the coating comprises nanoparticles and wherein the nanoparticles have a D50 from 1 to 1000 nm.

10. Filter device according to claim 1, wherein the permanent filter is formed temperature-resistant such that a temperature resistance of the permanent filter is higher than 500° C.

11. Filter device according to claim 1, wherein a metal filter is formed from at least one corrosion-resistant steel and/or from a nickel-based alloy and/or from copper and/or from mixtures or alloys thereof.

12. Filter device according to claim 1, wherein a mesh width of a filter material of the permanent filter is not more than 8 μm and/or at least 1 μm.

13. Filter device according to claim 1, wherein the permanent filter comprises a support structure which is designed to support a filter surface of the permanent filter, to keep it in shape and/or to increase the mechanical strength of the permanent filter, wherein the support structure extends parallel to a filter material of the permanent filter, at least in a partial region on the dirty gas side thereof and/or on the clean gas side thereof or is integrated in the permanent filter.

14. Filter device according to claim 1, wherein a diameter of fibres and/or wires which form a filter material of the permanent filter is less than 5 μm, wherein a diameter of wires which form a support structure has a thickness of more than 100 μm, and less than 1000 μm.

15. Filter device according to claim 1, wherein a dirty gas side of the permanent filter which comes into contact with the process gas to be purified has a pleated surface, meander-like, at least in certain regions, wherein a number of folds are arranged in the surface to form a pleated surface of the dirty gas side, wherein the folds for pleating are foldings in a continuous fabric or are welded and/or glued together.

16. Filter device according to claim 1, wherein the permanent filter is arranged in the filter device in such a way that a dirty gas side coming into contact with the process gas to be purified is an outer surface of the permanent filter and/or wherein the permanent filter is arranged in the filter device in such a way that a dirty gas side coming into contact with the process gas to be purified is an inner surface of the permanent filter.

17. Filter device according to claim 1, wherein the permanent filter is designed such that an oxidation reaction of particles present in the permanent filter can be initiated, wherein the permanent filter is coupled to an energy input source, and a metal mesh or a part of a metal mesh of the permanent filter constitutes a heating element.

18. Method for manufacturing a filter device for an additive manufacturing device for purifying a process gas of the additive manufacturing device, wherein the filter device for purifying a process gas during operation has at least one permanent filter according to claim 1, comprising the steps
selecting a material for the at least one coating of the permanent filter,
applying the at least one coating to the permanent filter.

19. Additive manufacturing device for manufacturing a component in an additive manufacturing process with a process space, a feed device for introducing a build-up material layer by layer into the process space, an irradiation unit for selective solidification of build-up material in the process space and with a filter device according to claim 1 for purifying a process gas of the additive manufacturing device.

20. Method for the additive manufacturing of a component in an additive manufacturing process by means of an additive manufacturing device, wherein the method comprises at least the following steps:
introducing at least one layer of a build-up material into a process space of the manufacturing device,
selective solidification of the build-up material in the process space by means of an irradiation unit and
purification of a process gas of the additive manufacturing device by means of a filter device according to claim 1.

21. Method for additive manufacturing according to claim 20, wherein the purification of process gas takes place at a process gas temperature of more than 300° C.

22. Method for additive manufacturing according to claim 20, wherein a cleaning of the permanent filter is carried out in dependence of a differential pressure value of process gas and wherein a differential pressure value is 15 to 30 mbar and/or wherein a cleaning pressure surge for cleaning the permanent filter is more than 4 bar and/or less than 5 bar.

23. Method for additive manufacturing according to claim 20, wherein a purification of process gas and/or a cleaning of the permanent filter is carried out in such a way that particles cleaned away from the permanent filter are usable as build-up material in an additive manufacturing process.

24. Method for additive manufacturing according to claim 20, wherein a cleaning of the permanent filter is carried out during the additive manufacturing process, without an interruption of the manufacturing process.
